(19) United States
(12) Patent Application Publication
(10) Pub. No.: US 2015/0317750 A1
(43) Pub. Date: Nov. 5, 2015

(54) EVENT AND LOCATION BASED SOCIAL NETWORKING SYSTEM

(71) Applicant: Marc N. Benhuri, New York, NY (US)

(72) Inventor: Marc N. Benhuri, New York, NY (US)

(21) Appl. No.: 14/267,661

(22) Filed: May 1, 2014

(51) Int. Cl. G06Q 50/00; G06F 17/30; H04L 29/06; H04L 29/08

(52) U.S. Cl. CPC G06Q 50/01; H04L 67/306; G06F 17/30876; H04L 67/22; H04L 65/403

(57) ABSTRACT

A system and method for establishing an event and location based social networking system is provided. A client application permits a user to create a profile, participate in events, and engage in a location-based social networking. The profile provides user information and characteristics the user seeks in other members. The system uses profile matching to permit social networking at an event or a location. The system also facilitates communications between users at a location/event, and enables users to initiate and engage in direct personal contact, if desired.

### BACKGROUND OF THE INVENTION

Online dating websites have become a popular way for singles to find partners for social activities, dating and marriage. There is an internet dating site for every taste and every budget—free dating websites, exclusive matchmaking services, ethnic and racially-focused dating sites, religious-oriented dating sites, and alternative lifestyle dating sites. No matter what a person is interested in, matches can be found through online dating and social media websites. Indeed, today there are nearly a billion people on one or more social networking sites, and millions of singles visit their favorite online dating sites every day.

Unfortunately, internet dating has several significant drawbacks. For example, males often complain that they get no responses, while females often complain that they get too many responses. Users also often complain that it takes too long to find a date, and that when they meet a partner he/she often does not look or act like they expected from pictures, descriptions and the like.

Certain dating services employ matching algorithms to identify potential matches. However, these services have significant drawbacks, since the algorithms focus on characteristics like personality and attitudes, which cannot accurately predict real-life interaction.

In the prior art, U.S. Pat. No. 8,108,414, entitled a “Dynamic location-based social networking,” discloses a method and system for establishing a location based social network in which a client application is provided on a communications device of a user seeking to establish a location based social network. The user creates a personal profile and a preference profile using the client application. The user transfers the personal and preference profiles to the social networking server which registers a location and range selected by the user. The social networking server identifies potential members within the registered location and range by matching the personal profile of each of the potential members with the preference and personal profiles of the user. The social networking server provides for communications between the user and the identified potential members upon mutual confirmation between the user and the identified potential members.

Also in the prior art, U.S. Pat. No. 8,204,513, entitled a “Location-based social software for mobile devices,” discloses a method of establishing a connection between users of mobile devices that includes receiving at a computer a location of a first user from a first mobile device, receiving from a second mobile device a location of a second user having an acquaintance relationship to the first user, and sending a message to the first mobile device based on the proximity of the first user to the second user.

The present invention overcomes many of the drawbacks of the prior art, and limitations that people encounter with online dating, and other forms of electronic, social or business interaction. By combining electronic social interaction with a venue or event, the system of the present invention permits individuals to identify persons of interest, see them, and if there is mutual interest, meet them in public in a social setting or event of interest. Such a system bridges the crucial gap between the time it takes to put a profile online, the time it takes to locate people of interest, and the time it takes to meet to determine whether the identified people are truly of interest. Moreover, by enabling a host of an event to select and implement rule-based contests, with rewards for winners and losers, the system promotes social interaction and the breaking down of social awkwardness which inhibits personal interactions in other systems.

### SUMMARY OF THE INVENTION

The following relates to systems and methods for an event and location based social networking system. More particularly, the following relates to a system, a method and a computer-readable-medium for engaging in social networking at specific locations or during specific events, including, for example, within a restaurant or bar.

Every guest has a tablet computer, or other electronic communication device that has the capability of communication via the Internet, or via a LAN or WAN, in order to access user profiles and send messages to other users at the location. For example, each table in a restaurant or other dining or meeting facility can be provided with a tablet computer, and be numbered, and each guest can send messages to the other tables based on the table numbers. Guests can see other patrons, look up their profile, and determine whether or not they wish to communicate directly with one another. User profiles can also contain information regarding customer preferences associated with the restaurant or venue, such as food, drink or seating preferences, or payment information.

An event and location-based social networking system for hosting and promoting interactions between multiple participants comprising: computer infrastructure, including a processor, a server, a user information management system for a host, a user communication system for users, and a database to store user data; a user connection to the infrastructure enabling a user to enter personal information and personal identifiers into the communication system which will be stored in the database; a user interface configured to enable users to communicate across the communication system; network connections that enable communications amongst users and between users and the host; a host interface that is configured to enable the host to provide services to users and to monitor and control communications between users; wherein the system is configured so that the host may promote interaction between users by initiating contests with rules that will require mental activity and interaction between users of the system.

A computer-implemented method of establishing an event and location-based social networking system, wherein the method utilizes at least one computer processor to implement the steps of: providing a client application on a communications device to a plurality of users; creating personal profiles and preference profiles by the users using the client application, wherein the preference profiles refer to characteristics sought by the user in potential members of the event and location-based social networking system; transferring the personal profiles and the preference profiles to a social networking server; registering a location for the event and location-based social network by the social networking server; identifying the potential members within the registered location comprising: creating a network among the potential members; matching the personal or preference profile of each of the potential members within the created network with the preference profile and the personal profile created by other users, providing a communications link between the user and one or more of the identified potential members upon mutual confirmation between the user and the one or more of the identified potential members; and enabling a host to promote interaction between users by initiating contests with rules that will require mental activity and interaction between multiple users.

### BRIEF DESCRIPTION OF THE DRAWINGS

The above and other objects and advantages of the invention will be apparent upon consideration of the following detailed description, taken in conjunction with the accompanying figures, in which like reference characters refer to like parts throughout, and in which:

FIG. 1 is an illustration of one possible system architecture for the event and location based social networking system of the present invention.

FIG. 2 illustrates a system for establishing an event and location based social networking system of the present invention.

FIG. 3 provides exemplary steps involved in using the system of the present invention.

FIG. 4 provides exemplary steps involved in hosting the system of the present invention.

FIG. 5 provides an exemplary screen shot of a user interface for the system of the present invention.

FIG. 6 illustrates a personal profile screen for a user interface for the system of the present invention.

FIG. 7 illustrates an initial group chat screen for a user interface for the system of the present invention.

FIG. 8 illustrates a combined group chat and private chat screen for a user interface for the system of the present invention.

FIG. 9 illustrates a private chat screen for a user interface for the system of the present invention.

FIG. 10 illustrates a user interface for the host user management system of the present invention.

FIG. 11 illustrates a host's user management screen for managing multiple users during social networking as part of the system of the present invention.

FIG. 12 illustrates a host's playlist management screen for managing interactive games as part of the system of the present invention.

FIG. 13 illustrates a host's user management screen for managing individual users during social networking in the system of the present invention.

### DETAILED DESCRIPTION OF THE EXEMPLARY EMBODIMENTS

The present invention is described below with reference to the illustrative diagrams in accordance with the invention. It is understood that the systems and apparatus described in each of the diagrams may be implemented by means of analog or digital hardware and computer program instructions. These computer program instructions may be provided to a processor of a general purpose computer, special purpose computer, ASIC, or other programmable data processing apparatus, such that the instructions, which execute via the processor of a computer or other programmable data processing apparatus, implements the functions/acts specified in the diagrams and text of this application.

Further, programs that implement such methods and algorithms may be stored and transmitted using a variety of media, for e.g., computer readable media in a number of manners. In a further embodiment, hard-wired circuitry or custom hardware may be used in place of, or in combination with, software instructions for implementation of the processes of various embodiments. Thus, embodiments are not limited to any specific combination of hardware and software. In general, the computer-readable programs may be implemented in any programming language. The software programs may be stored on or in one or more mediums as an object code. Where databases are described, alternative database structures may be readily employed, and other memory structures besides databases may be readily employed. The databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices are adapted to communicate with the computer. Any number and type of machines may be in communication with the computer.

Headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

### General System Overview

According to the system and method of the present invention, through the use of interactive mobile and touch screen technology, a typical social networking interaction experience may be transformed from a typical thirty-day or longer period of initial communication to a single day, single event experience. The system and method enables persons to initiate electronic interaction, and, if mutual interest is generated, permits them to engage in direct interpersonal interaction. Thus, non-personal electronic social experiences can be turned into live, personal social experiences within a restaurant, bar or other facility, if both parties are so interested.

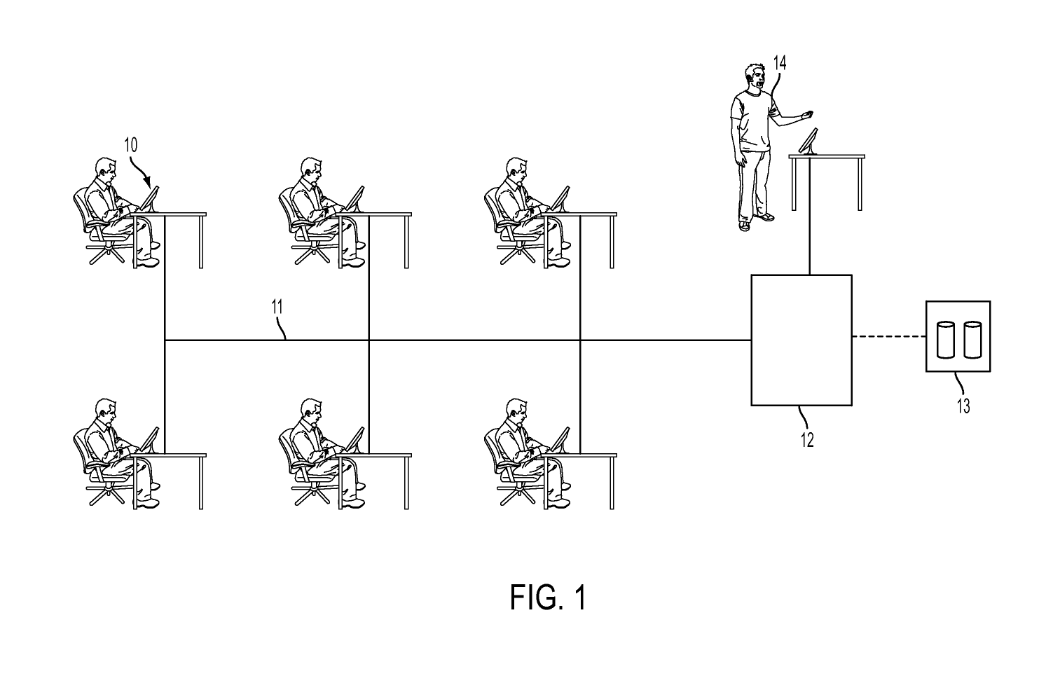

As shown in FIG. 1, within a facility, such as a restaurant, guests can use touch screens 10 to communicate via a wired or wireless network with guests at other tables. This interaction accomplishes two things. First, persons or groups can initiate communication with each other without fear of rejection, enabling them to engage in personal communication if there is mutual interest. Second, the facility can capture valuable marketing information from each guest that creates a profile and uses the system, resulting in an in-house database 13 accessible via a processor 12 that can be used for marketing and enhanced customer service. For example, with such a database 13, an administrator 14, such as facility personnel, can automatically identify a customer, can track how often that customer visits the facility, and can deliver personalized service, such as desired food and drink.

In order to use the system, each user must create an account to enroll and set-up a password. During the enrollment process, the system may be programmed to capture marketing information such as demographic information, system preferences, and desired food and beverages. The system and method can also capture credit card or other financial processing information, which can be used for payment of purchases, or for authentication purposes. The collected data may also be used to track use of the system, to discourage abuse of other users, and to recoup monies for theft or vandalism of equipment.

This example describes one of the many ways in which the system can operate. A user accesses the system website via a password and user identification. The website contains information regarding events that will be occurring within a specified time, such as during the next month. The website includes information to inform the user how he or she can sign up to participate in one or more listed events. For example, the website might list a forthcoming drinks and tapas event at a specified restaurant on a specified date at a specific time. The website might also list a beer tasting event approximately three weeks hence. The user could register for participation in one or both of those events and select the manner in which payment would be made. For example, payment could be made through a credit card associated with the user account or via an electronic payment service, such as PayPal.

Once a prospective user registers for one or both of the events he or she enters additional personal information relevant to the event, or information concerning the type of person he or she would like to meet at the event. On the date of the event at the time specified, the user logs in upon arriving at the location, either manually or electronically, including, for example, via a laptop, personal assistant, notebook, IPhone or other portable or mobile communications device, or a device provided by the facility. The log-in can be done either via the user's own device or a device supplied by the facility. After arrival, the user may thereafter go to a table, and either activate profile information previously entered or add additional information about who he/she would like to meet at the event. During the profile creation process, the system may be configured to access previously captured marketing information such as demographic information, system preferences, and desired food and beverages. The system can also capture valuable marketing information from each guest that uses the system during the event, which can be shared with the facility, in whole or in part, resulting in an in-house database that can be used for marketing and enhanced customer service. For example, with shared data, facility personnel can automatically identify a customer, track how often that customer visits the facility, and deliver personalized service, such as desired food and drink.

As various participants enter their information in the system, the user may find a match by reviewing user personal or preference profiles (depending on how the system is configured for the event or by each user) of persons attending the event, which can include photos of users. The system might also show the specific location or general position of users in the event room. Thus, the users can match profiles to participants, thereby enabling each user to see other participants, further enabling each of them to determine whether an actual meeting is desirable. If a meeting is desirable, one of the two could notify each other via the system, or live, and they can proceed arrange to meet at one table or the other.

### System Architecture

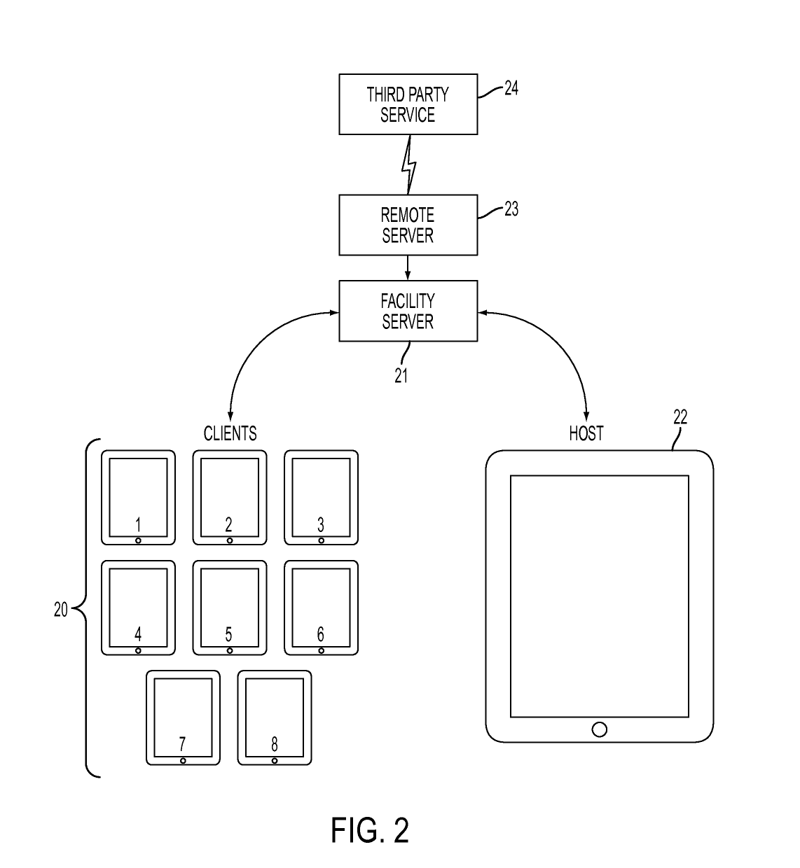

FIG. 2 exemplarily illustrates the architecture of the social networking system. The user may access the social networking server via a provided stationary communications device having connectivity to the social networking server, such as a mobile phone, a laptop computer, a tablet computer or other network capable device. The services and methods are controlled by a networked computer system, which typically manages all aspects of the hosted event. Such management systems typically include a local server, connected to servers that run from a remote location, to which the local server may be connected either by a wired or wireless network connection. The system is also connected via the local or remote servers to one or more databases and data storage systems and equipment, including back-up systems. However, alternative network configurations are possible, including configurations that include cloud based systems, as will be understood in the art.

As shown in FIG. 2, each table in a restaurant (or other dining or meeting facility) has a device that is able to communicate with devices at other tables at the restaurant (20). Each table has an identifying number which can be used to direct communication between tables e.g. table 1, table 2, table 3, etc. Guests seated at the tables can see each other and communicate first via the tabletop device.

The guest computers 20 or clients are networked to the facility server 21 which is also networked with the host 22. The restaurant (or other facility) has a technology platform and infrastructure that is a multi-tenant architecture that can reliably scale to support its business initiatives and growth. The architecture provides for business scalability and flexibility via a services-based architecture that is designed to enable business agility and continuously enhance business processes with state-of-the-art, technological innovation. Cloud-based infrastructure may alternatively be used with built-in redundancy or other forms of server architecture suitable to single or multiple facilities. This enterprise architecture provides the organizing logic for the business processes and information technology infrastructure reflecting the integration and standardization requirements of the restaurant's operating model.

The facility server 21 communicates with a remote server 23 to access and store basic user data. That remote server also manages client connections to a third party service 24. The third party service is a publish/subscribe system that is the primary facilitator of communication amongst guest computers and the host. As configured the system requires access to the Internet to communicate with the third party service. However, the third party service can be ported to be hosted on a local server if desired.

The system communicates via channels and events. When the system initializes, it subscribes its client to the third party service channels. Specifically, the guest computer will subscribe to a presence channel and multiple private channels. Every time the client subscribes to a channel, the system may begin to listen on those channels. For the most part, events dictate the flow of information that is seen in the system.

### System User Experience

The scope of the service offered varies depending on whether a user is a guest or a registered user. Guests and other public users may be offered a sign-up/quick sign-up. Registered users will be presented with a dashboard (home page), as well as subscription information (including the services subscription and payment gateway). The registration protocol can use an email address as the user identity, or can provide for the creation of a user id. The profile/id can also include basic personal information (name, age, etc.), appearance, background/values, lifestyle information, interests, information about preferred characteristics for those seeking to communicate (appearance, background/values, lifestyle and the like with the user), self-description in the user's own words, and photos (able to be displayed in a gallery) of the user. A user profile may be viewed and edited. Messaging (instant and via email) will also be provided, including filtering, sending, drafting and receiving of messages. Profile search options can include quick searching, custom searching, search saving, search sorting, profile viewing as well as matching to potential individuals for contact. Users may also track their connections and view those users who have looked at their profile or have favorited their profile, as well as making a list of favorite profiles of their own. A user may adjust account settings, including setting up automatic sign-in, blocking communications from undesirable individuals, setting message preferences, and changing or canceling membership. Administrative features allow management of subscriptions, reporting of abuse and editing the content on site. Event management features allow publication/notification of events, descriptive information of event locations, user subscription to events and creation of event-specific websites. A mobile version may also be used which will launch an app in a mobile phone or tablet browser. None of the foregoing features is limiting and additional features may be added.

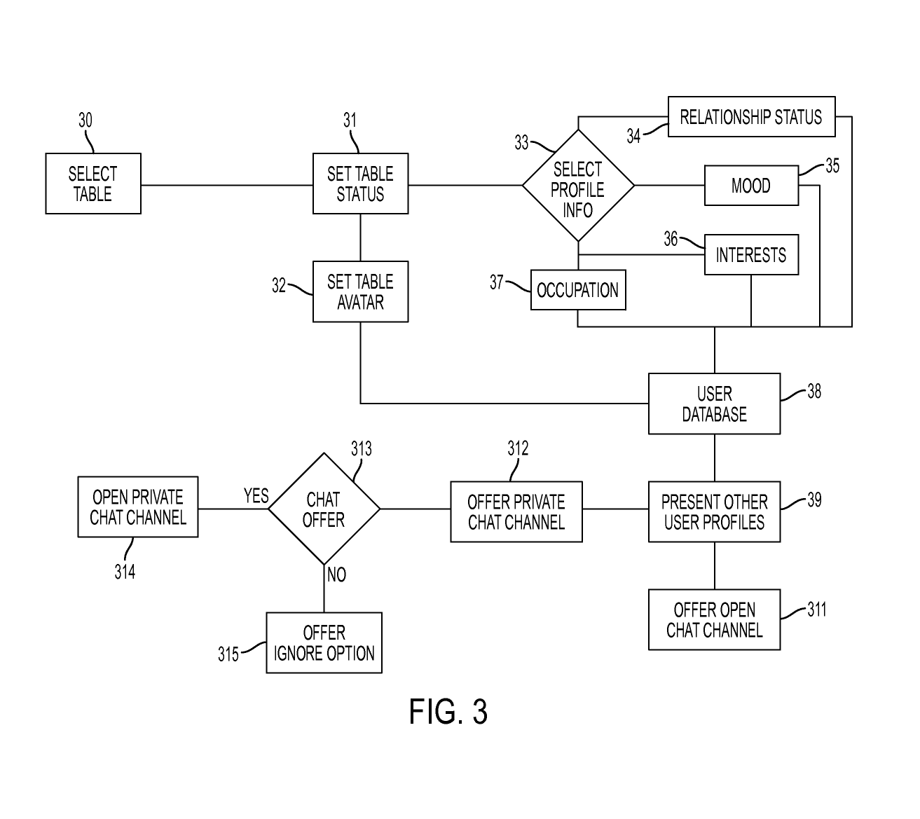

FIG. 3 illustrates the way in which the system will handle a new customer. Ordinarily, the customer will enter the facility and be shown to a table by staff. At the table, the customer will find an electronic interface (such as a laptop or electronic tablet) that is integrated with the table itself (so that the customer cannot remove the electronic interface from the table). The customer will automatically be presented with a screen on the electronic interface that enables the customer to begin to register his or her presence at that particular table 30. After responding to the initial interface prompt, the customer will be asked to set the table status 31. This will include setting a table avatar 32, which is a symbol that will be electronically displayed to represent the occupant of the table on the electronic interface. It will also include setting personal profile information 33, which can include signifiers for relationship status 34, mood 35, kinds of interests 36, and occupation 37. The system may provide either a dropdown menu of options for the customer to select for different personal profile subject categories or may allow the customer to type in their own descriptors. Once the customer has completed the personal profile information to their satisfaction, the system will prompt the customer to either accept the profile settings or reject them. If the customer accepts the settings, the customer's personal profile will be saved to the user database 38, which is either maintained by the facility on a local server at a remote server that is networked with the facility, or in the cloud. The customer may also designate which profile information may be shared with other users at the facility or event. Once the profile information for the customer is present in the user database, the system will then present other profiles to the customer 39. The system will also automatically connect the customer's electronic interface to the facility's open chat channel 311, which allows text messages to be read by all occupied tables at the facility as well as the host. In addition to automatically connecting the customer to the open chat channel, the system will also offer the customer the opportunity to open a private chat channel 312, which will establish a chat channel exclusively between the customer and another specified table. The invited customer may choose to extend or accept an offer to open a private chat channel with another table 313. If the customer accepts the offer to open a private chat channel 314, the system will open a private chat channel on both customer's electronic interfaces. If the customer refuses the offer to open a private chat channel made by another customer 315, the system will offer the invited customer the opportunity to automatically ignore all further such offers from that other table.

### System Host Experience

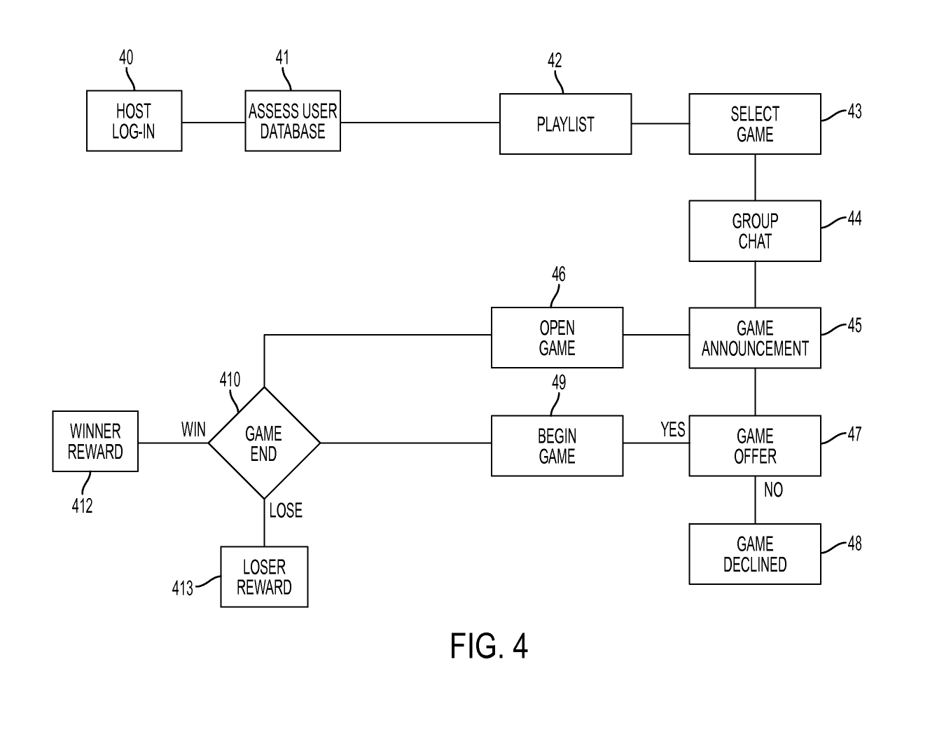

FIG. 4 illustrates how the system interacts with the host. The host will have a separate table (such as a reception desk or a desk located in a side office) which allows the host access to an electronic interface set up for host functions. The system will initially ask the host for specific information, such as a username and password, that will identify the host to the system 40. The host is automatically granted access to a host administrator interface, which will include display of all those profiles currently active in the user database 41. The host is able to review a listing of possible games that may be played by the occupied tables at the facility; this listing is called a playlist 42. The listed games may include, for example, quiz games, puzzle games, or any other form of social games suitable to electronic media without limitation. The system gives the option to the host of selecting a game to be played by the customers at the facility 43. The host may then choose a particular game option, at which point the system will provide the host with a connection to the open chat channel 44 and the system will then transmit an announcement of the game being played to the customers at the tables 45. Some games, such as a puzzle game, may be offered automatically to all tables without further need for the occupants of the tables to agree to participate 46. Other games, such as a card game, may require that the customers at the table actively consent to take part, in which case the system will make an offer to the customer to join in the game 47. If the offer to play a game is declined 48, the system does not proceed further. If the offer to play a game is accepted 49, the system will begin the game with the customer's participation. At the conclusion of the game being played, the system will determine which table is the winner of the game and which table(s) are losers of the game according to pre-set rules for any particular game 410. The system will then award a winner's reward 412, such as a beverage special to the winning table, and a loser's reward 413, such as a future food or drink discount at a later date to the loser's table. The nature of the rewards may be varied at the discretion of the host and the host may if desired not award losing tables anything. Games are rule-based contests that require mental activity and interaction between participants, which are intended to facilitate interaction.

### System User Interface

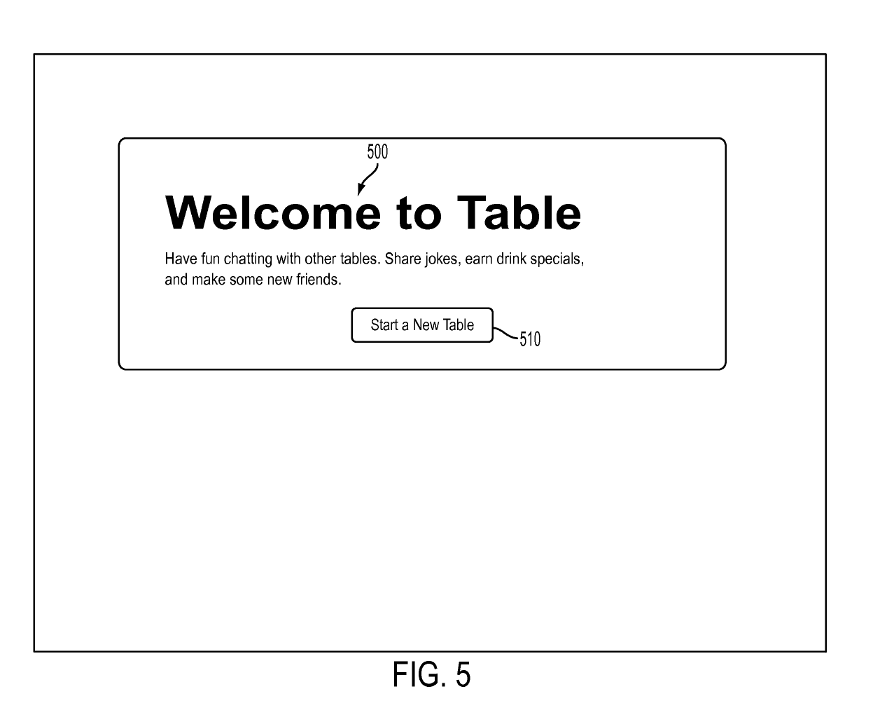

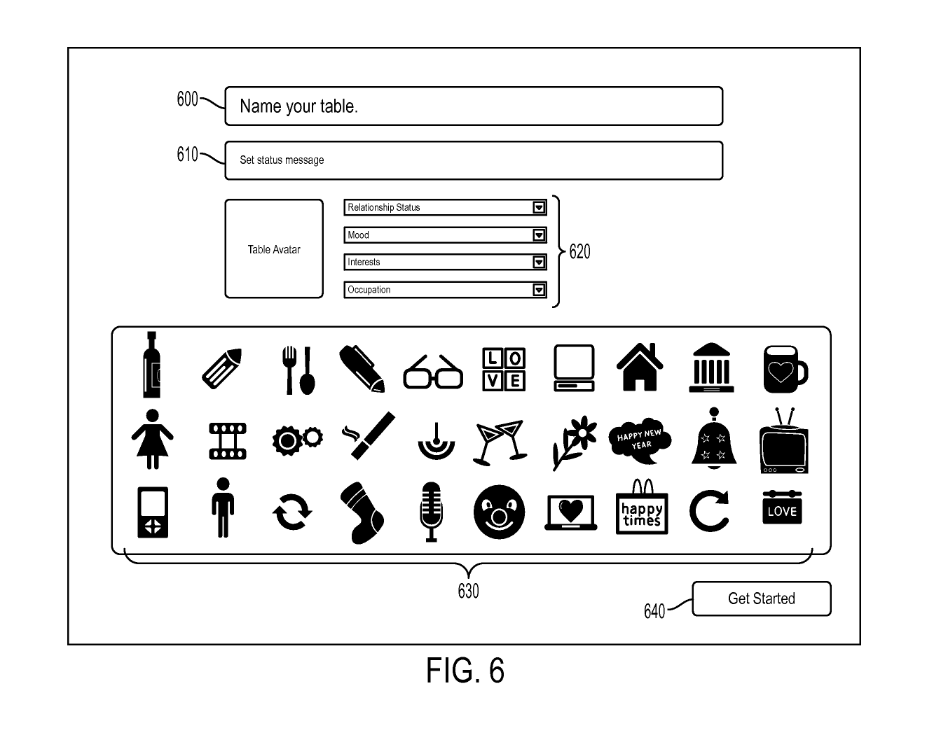

A graphical user interface (GUI) enables the user to join the event-based social networking system. In one embodiment, as shown in FIG. 5, the GUI begins by welcoming a customer 500 and providing a clickable electronic button to join the system 510. As shown in the example of FIG. 6, if the customer clicks to join the system then the GUI will offer a beginning screen asking the customer to name their table 600, set a status message that will be viewed by others 610, set personal profile information from drop-down menus including, for example, relationship status, mood, interests and occupation 620, and allow the customer to set a table avatar by selecting from a variety of symbols displayed on the screen 630, or by enabling the user to create their own avatar. Once the customer has completed the tasks on the beginning screen the customer may click to start wider interactions with the system 640.

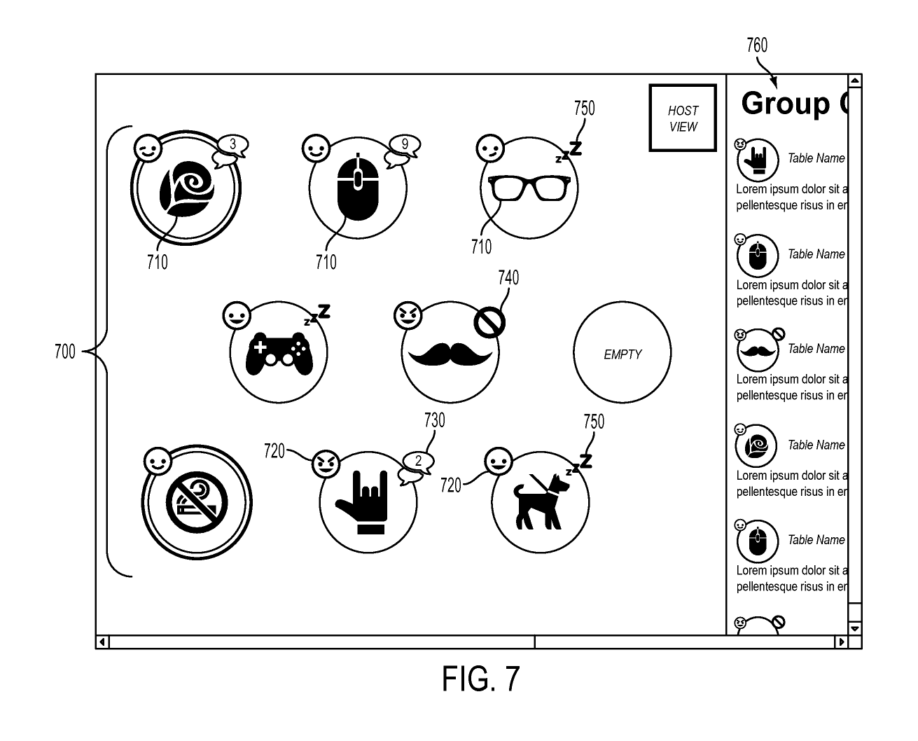

In one embodiment, as shown in FIG. 7, the user may search for potential persons to contact at the facility based on the displayed profile of other users. The GUI displays the floor layout of tables in the facility 700. For each table, a table avatar chosen by the table occupant(s) is displayed 710. Further identification of each table is shown visually by a face 720 (or another symbol) that indicates mood or another personal characteristic set by the user on the profile screen. Talk bubbles are shown indicating which tables are talking in chat channels at that time 730. Tables that do not wish to chat are able to put up a “stop” symbol 740. Tables that are inactive, that is they are neither chatting or joining in games for a certain period of time, will show a “sleep” symbol 750. A group chat channel is automatically displayed on the screen to the user 760. The user may participate in group chat at any time by typing a message into the group chat box.

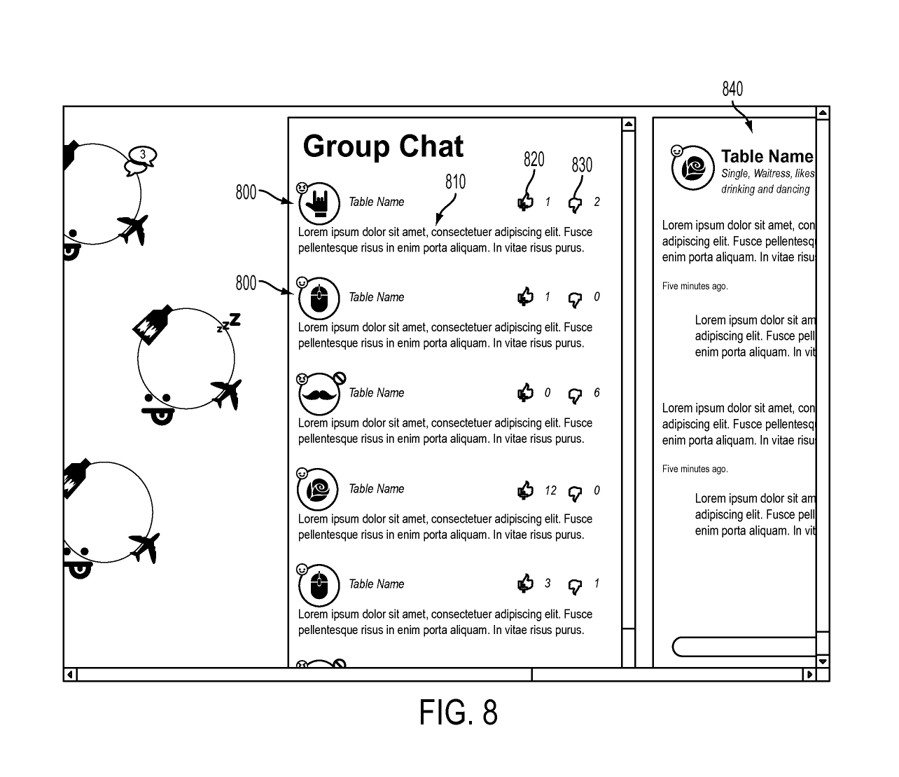

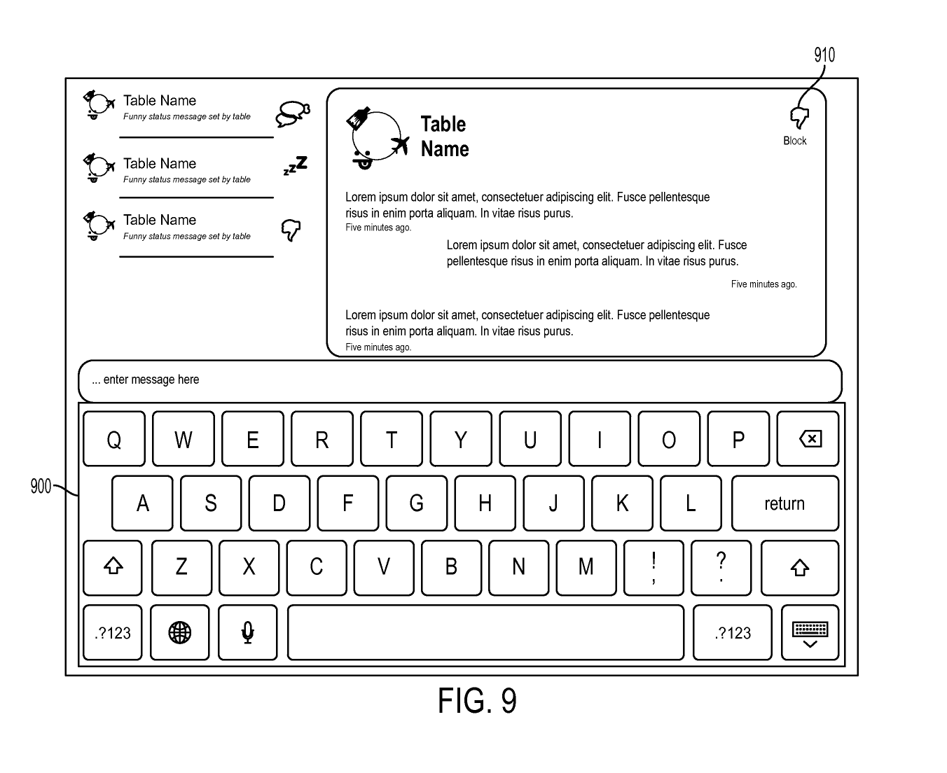

As shown in FIG. 8, the group chat channel displays the table avatars 800, table names 810, and enables comments to be clicked on as liked 820 or disliked 830. By clicking on a table avatar or name, the user may open a private chat channel 840. As shown in FIG. 9, the user is able to communicate by typing on a standard QWERTY keyboard 900 displayed on the screen, and can block communications with another table, for example, by clicking on a thumbs down symbol 910.

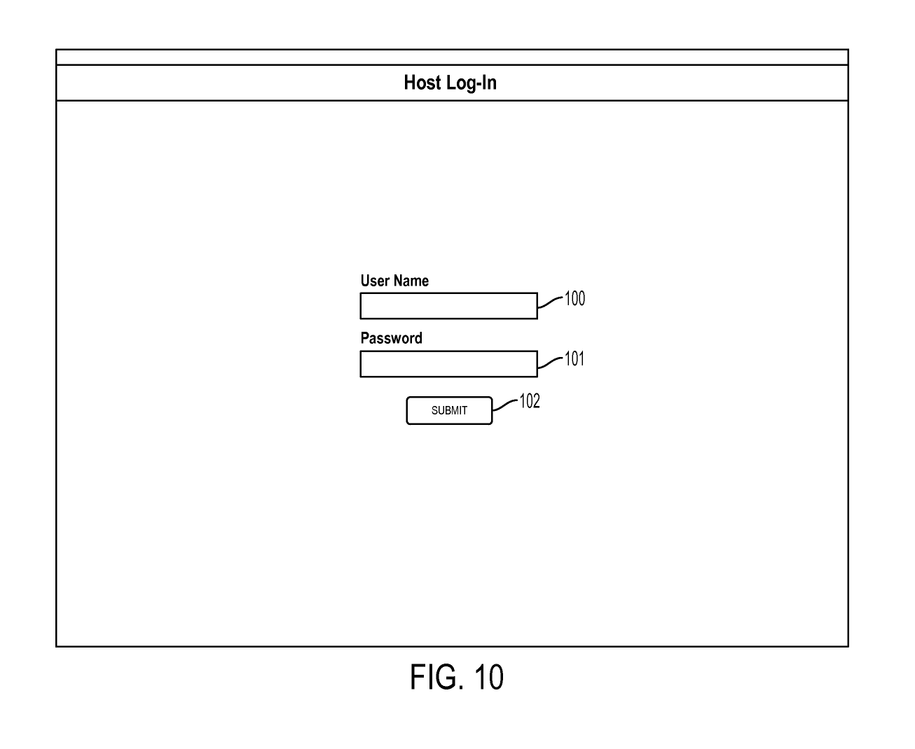

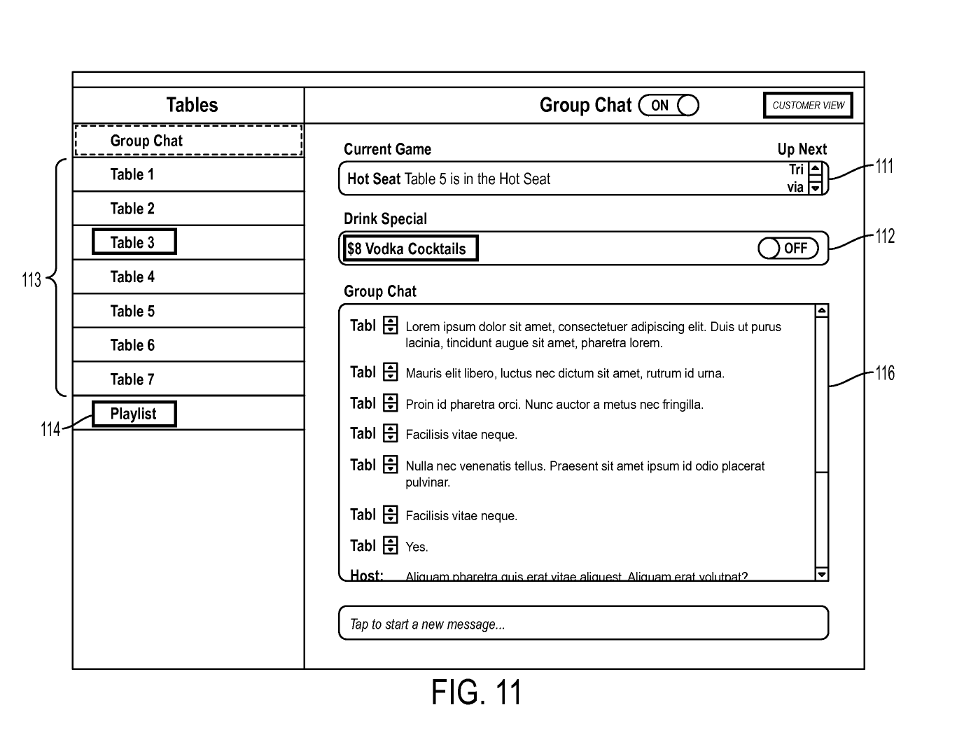

In one embodiment, as shown in FIG. 10, the system administrator, or other designated host, is presented with a log-in screen with prompts for a username 100 and password 101. The host enters the username along with the correct password and submits them to the system 102. As shown in FIG. 11, the host is displayed a version of the group chat channel 110, a drop down menu which shows the current game selected for the participation of tables 111, a toggle for drinks specials to be offered 112 and a listing of those tables currently active 113. The host may also access the listing of games via the playlist 114.

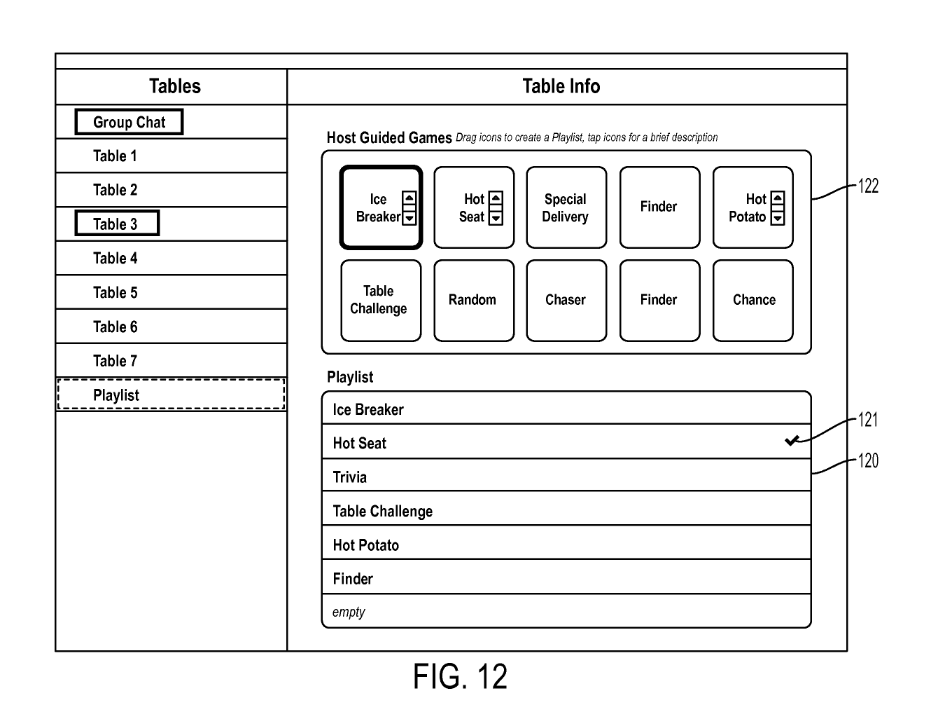

In one embodiment, as shown in FIG. 12 when the host clicks on the playlist, a playlist screen is displayed. The playlist panel shows the host a menu of games available for play by users 120. The currently active game is indicated by a tick symbol 121. The host is provided with a menu of host guided games 122. A playlist of games may be created by dragging game icons into the playlist panel.

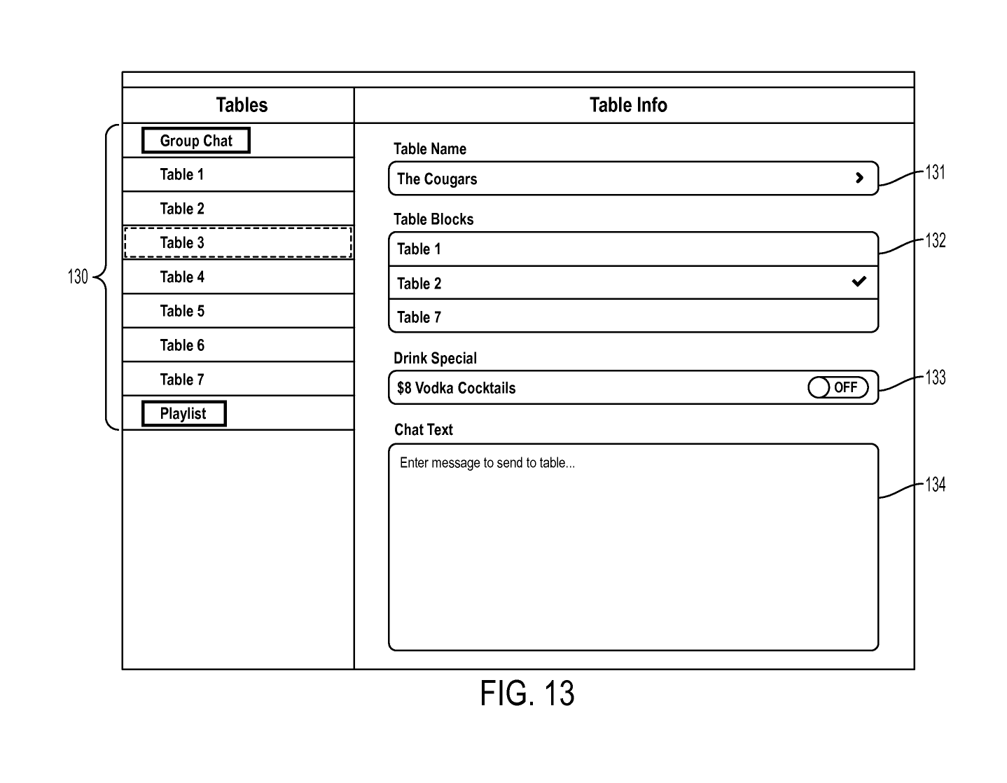

As shown in FIG. 13, the host is able to access a screen that shows specific information for each table. The tables are listed 130, the table name chosen by the occupants 131, tables that have been blocked from communication with a particular table 132, a toggle for drinks special that may be available to a particular table 133, and a panel which shows the chat text for each table 134. The host may have the ability to block communications between tables or otherwise remove communications from tables that do not follow rules of good behavior or correct use of language.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent systems and structures, methods and uses, such as are within the scope of the appended claims. Those skilled in the art, having the benefit of the teachings of this specification, may effect numerous modifications thereto and changes may be made without departing from the scope and spirit of the invention in its aspects.

While the foregoing is directed to embodiments of the present disclosure, other and further embodiments of the invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention.

What is claimed is:

1. An event and location-based social networking system for hosting and promoting interactions between multiple participants within a facility comprising:
computer infrastructure comprising a processor, a server, a communications network, a database, and data management software for storing and retrieving user profiles and other user information in the database;
user connections to the communications network, which enable a user to create, edit and manage a user profile comprising user data and preferences;
a facility having a plurality of user communication devices and a host communication device, each in communication with the communications network, thereby enabling users to access user data and preferences via the data management software, communicate with other users, and communicate with the facility host;
user communication software, enabling users to share identifiers, engage in group or one-on-one communication with other users, and to participate in facility-based group or one-on-one contests;
management software, for use by the host via the host communication device, to access user profiles and preferences to provide individualized services to each user and to monitor and control user communications with one another;
wherein users may visit the facility, utilize the communication devices to post and access user profiles, communicate with others at the facility, and request services from the facility.

2. The system of claim 1 wherein the management software further configures the host communication device to enable a host to restrict communications between users and to promote interaction between users by initiating and managing contests with rules that require mental activity and interaction between users.

3. The system of claim 2 wherein the management software further configures the host communication device to grant awards to contest winners and losers comprising food and beverage discounts and promotions at the facility.

4. The system of claim 2 wherein the management software further configures the system to enable the host to access user profiles via the data management software, and to initiate requests for food and beverage services on behalf of individual users at the facility in response to user profile data.

5. The system of claim 1 wherein the user communication software configures the user communication devices to enable a first user to block communications from a second user.

6. The system of claim 1 wherein the user communication software configures the user communication devices to enable a first user to initiate one-on-one communications with a second user.

7. The system of claim 1 wherein the user communication software configures the user communication devices to enable a first user to initiate group communications with other users.

8. The system of claim 1 wherein the management software configures the system to permit the host to invite individual users to participate in a group contest with rules that require mental activity and interaction between other users.

9. The system of claim 1 wherein the data management system collects and stores data comprising user participation in contests.

10. The system of claim 1 wherein the data management system collects and stores data comprising user food and beverage orders and preferences.

11. A computer-implemented method for location-based social networking, comprising:
a processor for executing software program instructions;
operating a database management system comprising software operating on the processor to enable each user to create a profile of user characteristics for sharing with other users, and to store the profile in a database;
registering a facility for a location-based social networking event, said facility comprising a server, a plurality of user communication devices, a host communications device, and a network enabling communications between the server, the user communication devices, the host communication device, and the database management system;
inviting users to participate in the registered event;
providing a client application on each user communications device at the facility during the registered event, enabling participating users to edit their profile information, access profiles of other participating users, and initiate communications with other participating users;
providing a host application on the host communication device at the facility during the event to enable the host to monitor and control communications between users, communicate with users, and promote interaction between users by initiating contests with rules that will require mental activity and interaction between multiple users;
wherein users may visit the registered facility for the event, utilize the communication devices to post and access user profiles, communicate with others, and communicate with the host to request services from the facility.

12. The method of claim 11 wherein the user application enables a first user to initiate one-on-one or group communications with a second user, further comprising the step of a first user initiating a one-on-one or group communication with another user.

13. The method of claim 12 further wherein the user application enables a first user to initiate group communications with other users, further comprising the step of the first user initiating a group communication with other users.

14. The method of claim 12 wherein the client application enables a first user to block communications from another user, further comprising the step of a first user blocking communications from a second user.

15. The method of claim 11 wherein the host and client applications further enable the host to initiate and users to participate in facility-based group or one-on-one contests during the event, further comprising the step of the host initiating a group contest.

16. The method of claim 15 wherein the host application permits the host to invite individual users to participate in a group contest.

17. The method of claim 15 wherein the host application enables the host to grant awards to contest winners and losers, further comprising the step of the host granting promotions at the facility in response to contest performance.

18. The method of claim 11 wherein the host application enables the host to access user data from the data management software, further comprising the step of the host accessing user data and electronically requesting food and beverage services to individual users at the facility in response to user profile data.

19. The method of claim 11 further comprising the step of operating the data management system to collect and store data comprising user participation in contests.

20. The method of claim 12 further comprising the step of operating the data management system collect and store data comprising user food and beverage orders and preferences.

21. The method of claim 11 wherein the database management system software enables each user to create and store a personal profile and one or more preference profiles, further comprising the step of a user responding to an invitation to participate in an event and selecting a preference profile for sharing with other users at said event.
